(19) United States
(12) Patent Application Publication
(10) Pub. No.: US 2026/0029973 A1
(43) Pub. Date: Jan. 29, 2026

(54) STORAGE MEDIUM, CONTROL METHOD OF INFORMATION PROCESSING APPARATUS, AND INFORMATION PROCESSING APPARATUS

(71) Applicant: CANON KABUSHIKI KAISHA, Tokyo (JP)

(72) Inventor: KINYA HONDA, Chiba (JP)

(21) Appl. No.: 19/274,340

(22) Filed: Jul. 18, 2025

(30) Foreign Application Priority Data
Jul. 23, 2024 (JP) 2024-117583

(51) Int. Cl. G06F 3/12

(52) U.S. Cl. CPC G06F 3/1255; G06F 3/1205; G06F 3/1208; G06F 3/123; G06F 3/1256; G06F 3/1287

(57) ABSTRACT

A non-transitory computer-readable storage medium stores an application program which causes an information processing apparatus to perform a control method, the application program cooperating with an Internet Printing Protocol (IPP) Class Driver. The control method includes accepting a setting on conversion of a file to be printed, and, when a setting not to perform the conversion is accepted and a font used in the file to be printed is not embedded in the file to be printed, embedding the font.

### BACKGROUND

### Field of the Technology

The present disclosure relates to a storage medium storing an application program that supports printing software for outputting print data to image forming apparatuses produced by a plurality of manufacturers, a control method of an information processing apparatus, and an information processing apparatus.

### Description of the Related Art

In recent years, there have been proposed “general-purpose printer drivers (local printer drivers)” that perform printing and communications using an industry standard protocol such as Internet Printing Protocol (IPP). There have been also proposed “general-purpose printer drivers (cloud printer drivers)” that communicate with cloud print servers. Such “general-purpose printer drivers” can communicate with printers from a plurality of types of printer vendors. Users can send print data to a printer connected to a personal computer (PC) or a cloud print server and print the data even without installing a vendor (maker, manufacturer)-specific printer driver.

Conventionally, in printing using a “general-purpose printer driver,” a file output by an application is once converted to “Extensible Markup Language (XML) Paper Specification (XPS®) format”. The file having been converted to XPS format is then converted to “Portable Document Format (PDF) format)” and transmitted to the printer (e.g., refer to Japanese Patent Application Laid-Open No. 2020-46741).

In contrast, some applications that run on PCs directly output files in PDF format. Currently, in a case where an application can directly output files in PDF format or the like, the process of converting a PDF format file or the like into XPS format is omitted.

Thus, even in a case of using a general-purpose printer driver, it is being under discussion how to send PDF format files output by applications directly to the printer. If it were possible to print PDF format files directly, the following matter would occur. Users would be required to choose between converting a file to XPS format first and then printing as in the past, or directly printing a PDF file. For this purpose, it may be assumed that users will be prompted to make the selection on the print setting screen of the “general-purpose printer driver”.

Incidentally, a font can be embedded in PDF files, and font information including a glyph that determines the appearance of characters can be stored in PDF files.

In a case where a font is not embedded in a PDF file, the application for displaying PDF files will display characters using the font that exist in the operating system (OS) or the like. In a case where the system does not have the appropriate font, some alternative font will be used. This may result in characters that look different from the original or garbled characters.

In contrast, when the font is embedded in a PDF file, the font can be displayed or printed as an original, even if the system of the file opener side does not have the font.

In printing with a “general-purpose printer driver”, a font present in the system can be embedded in a PDF file at the time of printing.

As described in the background technique, in printing using a “general printer driver”, a file output by an application is converted to XPS format once. The file converted to XPS format is then converted to PDF and transmitted to the printer. When converting the XPS format file into PDF, the general-purpose printer driver can embed a font installed in the operating system into the PDF file.

That is, even if a font is not embedded in the original PDF file output from the application, the font installed in the OS can be embedded in the PDF file at the time of printing with a “general-purpose printer driver”.

However, in the case of directly printing a PDF file, a font cannot be embedded in the PDF file because the original PDF file is sent directly to the printer.

At the time of printing with a “general-purpose printer driver”, in the case where the font is not embedded in the PDF file but the font exists in the OS, the font can be embedded in the PDF file before sending to the printer. This allows the file to be printed as the original.

However, in systems that directly print a PDF file, in the case where a font is not embedded in the PDF file, even though the font exists in the OS, the PDF file without the font embedded is sent directly to the printer. In the case where the font does not exist in the printer, an alternative font is used for printing. This may result in characters that look different from the original, or garbled characters. A printing error may also occur when an alternative font is not found.

### SUMMARY

Embodiments of the present disclosure are directed to making it possible to obtain a desired print result in a case of printing using a general-purpose printer driver.

According to embodiments of the present disclosure, a non-transitory computer-readable storage medium stores an application program which causes an information processing apparatus to perform a control method, the application program cooperating with an Internet Printing Protocol (IPP) Class Driver. The control method includes accepting a setting on conversion of a file to be printed, and, when a setting not to perform the conversion is accepted and a font used in the file to be printed is not embedded in the file to be printed, embedding the font.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating a configuration of a printing system according to exemplary embodiments.

FIGS. 2A to 2E are block diagrams illustrating configurations of apparatuses according to the exemplary embodiments.

FIGS. 3A and 3B illustrate a sequence diagram of a print process (print setting extension application).

FIG. 4 illustrates a sequence diagram to which processing of the print setting extension application according to the exemplary embodiments is added.

FIG. 5 is a diagram illustrating an example of an initial print setting screen in a document generation application.

FIG. 6 is an explanatory diagram of “ability information” of a cloud print-compatible printer.

FIGS. 7A to 7D are diagrams illustrating examples of print setting screens in a case of absence of the print setting extension application.

FIGS. 8A to 8E are diagrams illustrating examples of print setting screens in a case of presence of the print setting extension application.

FIG. 9 is a diagram illustrating an example of a PDF pass-through setting screen in the cloud print-compatible printer.

FIG. 10 illustrates a flowchart according to a first exemplary embodiment.

FIG. 11 illustrates a flowchart according to a second exemplary embodiment.

FIG. 12 is a diagram illustrating an example of a font embedding confirmation dialog according to the second exemplary embodiment.

FIG. 13 illustrates a flowchart according to a third exemplary embodiment.

FIG. 14 illustrates an example of a print confirmation dialog according to the third exemplary embodiment.

FIG. 15 illustrates a flow chart of a fourth exemplary embodiment.

### DESCRIPTION OF THE EMBODIMENTS

Hereinafter, exemplary embodiments of the present disclosure will be described in detail with reference to the drawings. The configurations of the following exemplary embodiments described below are merely examples, and the scope of the present disclosure is not limited to the configurations of the exemplary embodiments. In this specification, an application program that extends (supports) the print setting function of a general-purpose printer driver installed in an operating system (hereinafter, referred to as “OS”) of a client terminal 101 will be referred to as a “print setting extension application” or a “support application”. The “general-purpose printer driver” may also be referred to as a “standard driver”.

### System Configuration

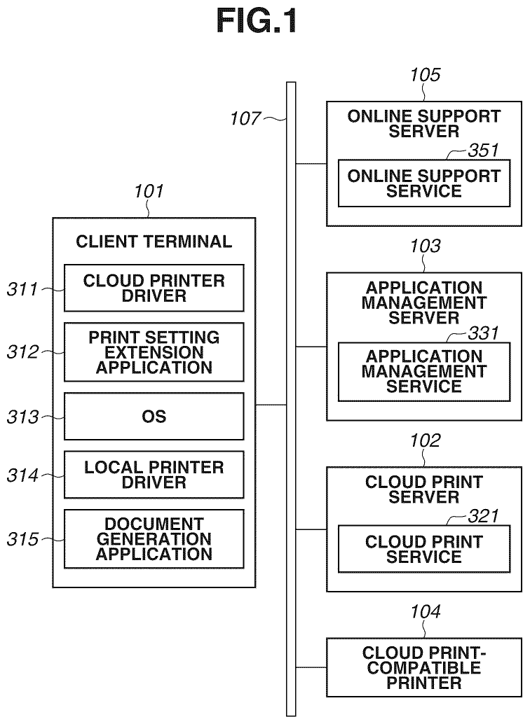

FIG. 1 illustrates an overall configuration of a printing system according to exemplary embodiments of the present disclosure. The printing system is a system capable of cloud printing. The printing system includes a client terminal 101, a cloud print server 102, an application management server 103, a cloud print-compatible printer 104, and an online support server 105. These are connected with one another via a network 107 such that they can communicate required information.

FIG. 1 illustrates only one each of the client terminal 101 and the cloud print-compatible printer 104, there can be a plurality of client terminals 101 and a plurality of cloud print-compatible printers 104. Each of the cloud print server 102, the application management server 103, and the online support server 105 can consist of a plurality of information processing apparatuses. The servers 102, 103, and 105 can be configured as a server system consisting of a plurality of information processing apparatuses to perform load distribution.

The cloud print server 102, the application management server 103, and the online support server 105 can be virtually configured inside one physical information processing apparatus. The network 107 is assumed to be a wide area network (WAN) such as the Internet that can provide cloud services. Alternatively, all of the servers can also be in a closed communication environment such as an in-house local area network (LAN).

### (Client Terminal)

In the client terminal 101, a cloud printer driver 311, a print setting extension application 312, and a local printer driver 314 are installed together with an operating system (OS) 313.

The cloud printer driver 311 and the local printer driver 314 can be general-purpose printer drivers provided by the manufacturer of the OS 313 and included (packaged) in advance in the OS 313. In this case, the cloud printer driver 311 and the local printer driver 314 become available for use when the OS 313 is installed in the client terminal 101, or when the client terminal 101 equipped with the OS 313 is purchased. A general-purpose printer driver can generate print data that can be printed in common on printers from a plurality of manufacturers, but can only accept limited print settings determined by standards such as Internet Printing Protocol (IPP).

As a general-purpose printer driver, an IPP class driver that is included in advance in Windows® is known, for example.

Since the general-purpose printer driver is included in the OS 313, in the following description, the processing in the general-purpose printer driver and the processing in the OS 313 for printing may be collectively referred to as processing by the OS 313. The general-purpose printer driver (cloud printer driver 311 and/or local printer driver 314) and the OS 313 can also be collectively referred to as “printing software”.

The print setting extension application 312 is an application program provided by the printer manufacturer (provider), and is also referred to as a Print Support Application (PSA). Even if characteristic print settings (stapleless binding, saddle folding, and the like) are available in each printer, these settings often cannot be set in the general-purpose printer driver. Thus, the printer manufacturer provides the print setting extension application 312 that supports the functions of the general-purpose printer driver to allow the above-described characteristic print settings. The client terminal 101 can acquire device identification information (hardware ID: HWID) from the printer, and download and install the application program corresponding to the printer identification information.

The client terminal 101 is an information processing apparatus such as a personal computer (PC), a tablet, and a smartphone, and is a terminal that can be directly operated by a user. The client terminal 101 is capable of executing required application software on an OS or middleware.

### (Cloud Print-Compatible Printer)

The cloud print-compatible printer 104 is a printing device that actually prints on a recording medium such as paper. For example, the cloud print-compatible printer 104 is an image forming apparatus (MFP) equipped with a plurality of functions including a print function by which to convert print data received via the network 107 into image data and print the same, a fax function, and a copy function. MFP is an abbreviation for multi-function peripheral. The cloud print-compatible printer 104 can receive print data from the client terminal 101 via the cloud print server 102, and can also receive print data directly from the client terminal 101 without involving the cloud print server 102.

The cloud print-compatible printer 104 receives print data generated by the cloud printer driver 311 installed in the client terminal 101 via the cloud print server 102. The cloud print-compatible printer 104 can also receive print data generated by the local printer driver 314 installed in the client terminal 101 without involving the cloud print server 102 to execute printing the print data.

### (Cloud Print Server)

The cloud print server 102 includes a cloud print service 321. The cloud print service 321 receives a print instruction and print data from an external device. The cloud print server 102 then transmits the received print data to the cloud print-compatible printer 104 specified by the print data. In the present exemplary embodiment, the image data and print setting information (print ticket (PT)) will be collectively referred to as “print data”.

### (Application Management Server)

The application management server 103 includes an application management service 331. The application management service 331 holds and manages various applications. The application management service 331 receives application identification information and a download request from the client terminal 101, and transmits, to the client terminal 101, an application identified based on the received identification information.

### (Online Support Server)

The online support server 105 includes an online support service 351. The online support service 351 provides a support service online. The online support service 351 is a server device for providing the client terminal 101 with an extension setup information file in which information for extending the functions of the client terminal 101 is described.

### Hardware Configuration

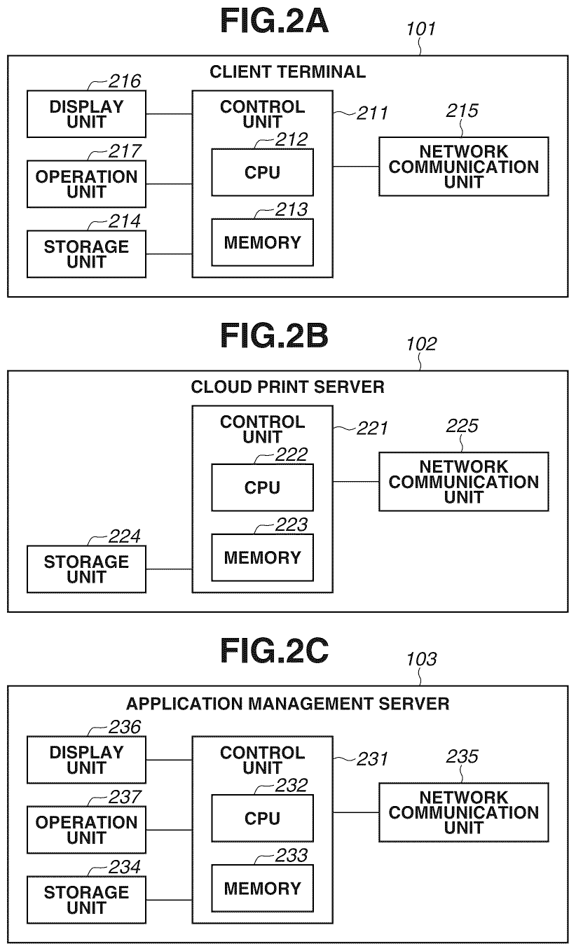

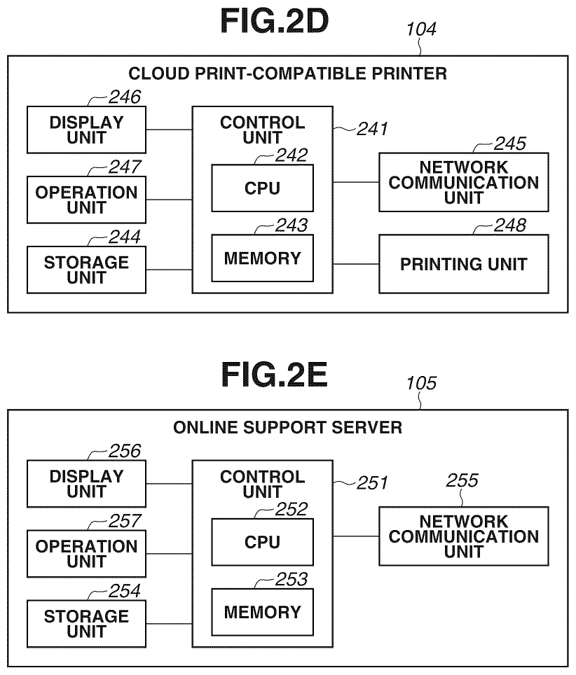

Next, hardware configurations of the servers 102, 103, and 105, the client terminal 101, and the cloud print-compatible printer 104 in the printing system of the present exemplary embodiment will be described with reference to FIGS. 2A and 2B (hereinafter, also collectively referred to as “Fig. 2”).

### (Client Terminal)

FIG. 2A is a block diagram of a hardware configuration of the client terminal 101. The client terminal 101 includes a display unit 216, an operation unit 217, a storage unit 214, a control unit 211, and a network communication unit 215.

The display unit 216 is a display device such as a liquid crystal display, and displays information that is visible to the user.

The operation unit 217 is an input device, such as a keyboard and a mouse, for accepting input from the user. A device having the functions of both the display unit 216 and the operation unit 217, such as a touch panel, can also be used.

The storage unit 214 is a storage device such as a hard disk, an solid-state drive (SSD), or a flash memory, which stores data in a rewritable and non-volatile manner.

The control unit 211 includes a central processing unit (CPU) 212 and a memory 213, and controls the overall operation of the client terminal 101. The CPU 212 develops a program stored in the storage unit 214 into the memory 213, and executes the developed program. The memory 213 is the main memory of the CPU 212, and has a work area and a temporary storage area for developing various programs.

The network communication unit 215 transmits and receives digital data to and from the external servers 102, 103, and 105 and the cloud print-compatible printer 104 via the network 107.

### (Cloud Print Server)

FIG. 2B is a block diagram of a hardware configuration of the cloud print server 102. The cloud print server 102 includes a storage unit 224, a control unit 221, and a network communication unit 225. The storage unit 224, the control unit 221, and the network communication unit 225 are equivalent to the corresponding units of the client terminal 101, and thus description thereof will be omitted.

As illustrated in FIG. 2B, in the present exemplary embodiment, the cloud print server 102 is constituted of one information processing apparatus, but the cloud print server 102 can be a server system constituted of a plurality of information processing apparatuses. The storage unit 224 of the cloud print server 102 stores programs for various services provided by the cloud print server 102, in a non-volatile manner. These programs are developed in the memory 223 at the time of startup of the cloud print server 102. The developed programs are executed by the CPU 222 to implement the cloud print service 321.

### (Application Management Server)

FIG. 2C is a block diagram of a hardware configuration of the application management server 103. The application management server 103 includes a display unit 236, an operation unit 237, a storage unit 234, a control unit 231, and a network communication unit 235. The display unit 236, the operation unit 237, the storage unit 234, the control unit 231, and the network communication unit 235 are equivalent to the corresponding units of the client terminal 101, and thus description thereof will be omitted.

The storage unit 234 of the application management server 103 stores programs for various services provided by the application management server 103, in a non-volatile manner. These programs are developed in the memory 233 at the time of startup of the application management server 103. The developed programs are executed by the CPU 232 to implement the application management service 331.

As illustrated in FIG. 2C, the application management server 103 is constituted of one information processing apparatus, but the application management server 103 can also be a server system constituted of a plurality of information processing apparatuses.

### (Cloud Print-Compatible Printer)

FIG. 2D is a block diagram of a hardware configuration of the cloud print-compatible printer 104.

The cloud print-compatible printer 104 includes a display unit 246, an operation unit 247, a storage unit 244, a control unit 241, a network communication unit 245, and a printing unit 248.

The display unit 246 is a display device, such as a touch panel or light-emitting diode (LED), provided on the cloud print-compatible printer 104, which displays information that is visible to the user.

The operation unit 247 is an input device for accepting input from the user, and can have hard keys such as a numeric keypad in addition to a touch panel that allows touch operations.

The storage unit 244 and the control unit 241 are equivalent to corresponding units of the client terminal 101, and thus description thereof will be omitted.

The network communication unit 245 communicates with the external network 107. The network communication unit 245 mainly receives print data, but also has a function of transmitting information indicating its own status, such as error information, to an external server.

The printing unit 248 executes a printing process by performing a series of operations of paper feeding, printing, and paper ejection, on a sheet of paper that is a printing medium prepared in a cassette or tray. The printing method is not particularly limited, and can be electrophotographic printing or inkjet printing. The printing unit 248 also includes a finishing device such as a duplex unit, stapler, and puncher, which can be used at the time of paper ejection. In the present exemplary embodiment, a multifunction device (such as an MFP) having a plurality of functions is taken as an example of the cloud print-compatible printer 104, but a single-function printer that only performs a print function can also be used.

### (Online Support Server)

FIG. 2E is a block diagram of a hardware configuration of the online support server 105. In the present exemplary embodiment, the online support server 105 is constituted of one information processing apparatus, but can be constituted of a plurality of information processing apparatuses. The online support server 105 includes a display unit 256, an operation unit 257, a storage unit 254, a control unit 251, and a network communication unit 255.

The display unit 256 and the operation unit 257 are similar to the display unit 216 and the operation unit 217 of the client terminal 101, and thus description thereof will be omitted.

The storage unit 254 is a rewritable, non-volatile memory device such as a hard disk device (HDD), an SSD, or a flash memory. The storage unit 254 stores an extension setup information file that is a file describing information for extending functions provided by the client terminal 101. The storage unit 254 also stores programs for various services provided by itself.

These programs are developed in its own memory 253, and the developed programs are executed by the CPU 252 to implement the online support service 351.

The control unit 251 includes the CPU 252 and the memory 253.

The CPU 252 controls the overall operation of the online support server 105.

The memory 253 stores various data generated by the CPU 252 executing the programs.

The network communication unit 255 is an interface for the online support server 105 to communicate with the client terminal 101. The online support server 105 receives an acquisition request for a file stored in the storage unit 254 via the network communication unit 255, reads the corresponding file from the storage unit 254, and transmits the corresponding file to the client terminal 101.

### Process Sequence From “Print Setting” to “Print Data Transmission”

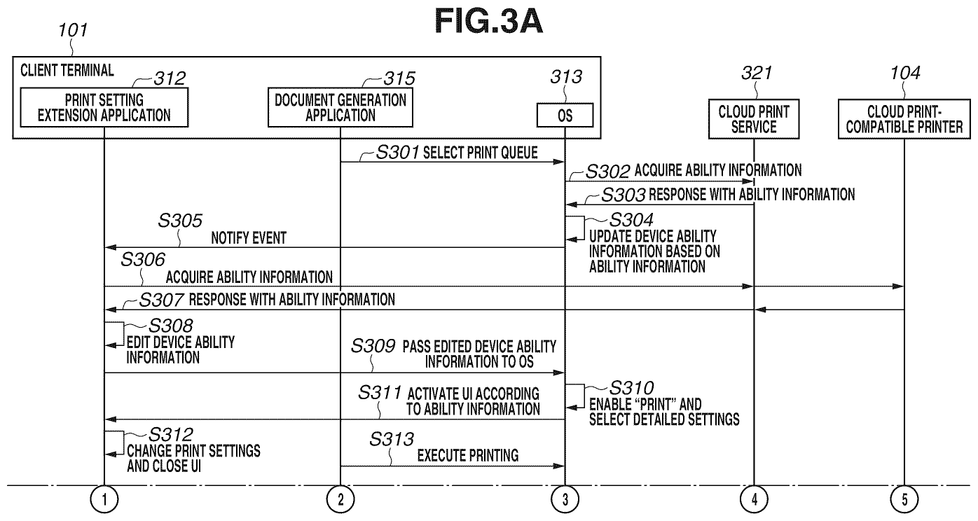

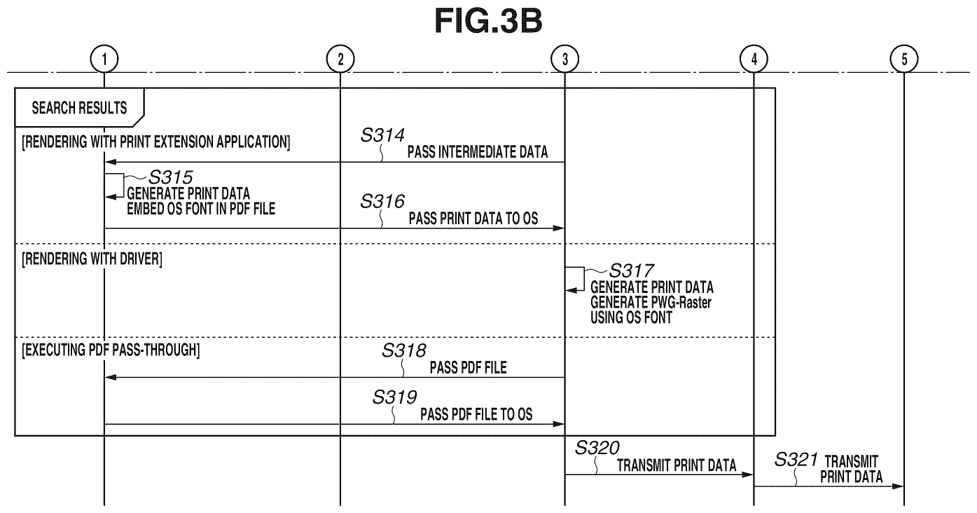

Next, a process sequence from “print setting” in the client terminal 101 to “print data transmission” to the cloud print-compatible printer 104 will be described with reference to FIGS. 3A and 3B.

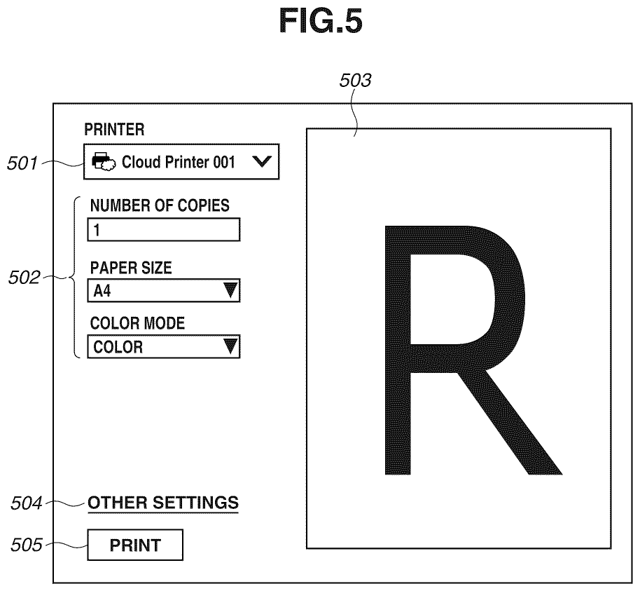

A document generation application 315 displays a print setting initial screen (see FIG. 5) for selecting a print queue on the display unit 216. The document generation application 315 is an application for generating document files such as an application for generating document data, an application for generating presentation materials, and an application for displaying photo and image data.

### (Print Setting Initial Screen)

FIG. 5 illustrates the print setting initial screen. The print setting initial screen displays an object 501 for selecting a printer, an object 502 for making print settings, and a print preview 503. The print setting initial screen also displays an object 504 for other settings, and a [Print] button 505.

First, in step S301, the OS 313 detects that the user has selected a printer to be used via the object 501, and selects a print queue. Specifically, the document generation application 315 transmits print queue selection information to the OS 313. The following description will be provided on the assumption that the print queue of the default printer has been selected at the start of the display of the print setting initial screen.

In step S302, the OS 313 transmits an ability information acquisition request for acquiring printer ability information to the cloud print service 321. The OS 313 transmits the ability information acquisition request to the cloud print service 321 with specification of the printer name selected in the object 501 on the print setting initial screen.

The inquiry about ability information is made to a cloud print service unit 325 that registers the cloud print-compatible printer 104 by using a standard protocol defined by an IPP, such as Get-printer-Attributes. In the case of using Get-printer-Attributes, the inquiry is made in the form of a list of ability information set by the OS 313.

### (Example of Ability Information)

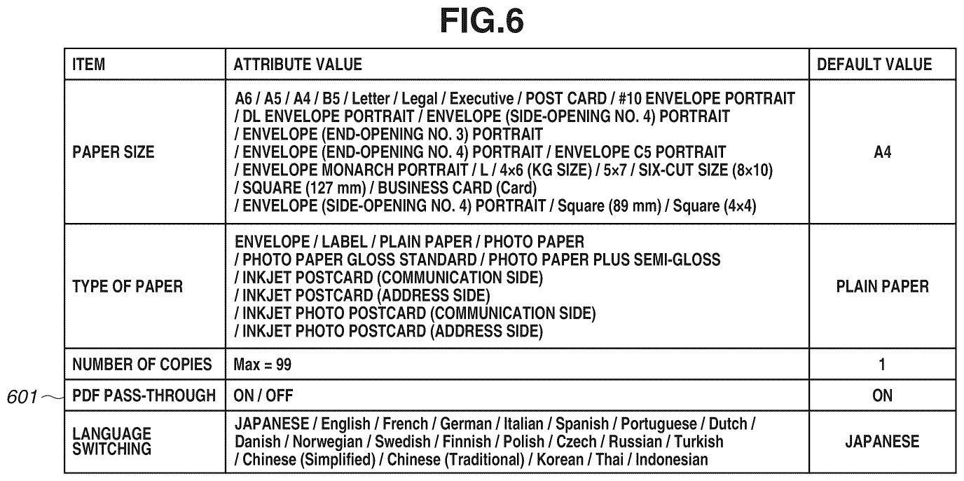

The ability information to be acquired will be described with reference to FIG. 6.

In the present exemplary embodiment, the IPP is used as a communication protocol for communicating ability information, and the cloud print service 321 acquires items, attribute values, and default values as illustrated in FIG. 6 from the cloud print-compatible printer 104.

The items correspond to the setting items of print setting information, and the attribute values correspond to the options and setting value ranges of the setting items, and the default values correspond to the setting values. The items and attribute values stored in the cloud print-compatible printer 104 include information defined in industry standard specifications by the IPP and information defined independently by the printer vendor. The information defined independently by the printer vendor includes items and attribute values defined independently by the printer vendor. For example, items not illustrated in FIG. 6 can include “job name shortening” and “stapleless binding”.

In the present exemplary embodiment, the vendor-specific items include a PDF pass-through setting 601. The PDF pass-through setting 601 is an item that defines whether to use a function (PDF pass-through) of printing a PDF file generated by an application without converting into XPS file format at the time of execution of printing from a standard driver (ON: enabled, OFF: disabled). In a case where the PDF pass-through setting 601 is not set (OFF: disabled), in printing the PDF file, the application calls an Application Programming Interface (API) prepared by the OS 313. The OS 313 then converts the PDF file to be printed into XPS file format and then reconverts the same into PDF file format.

### (Example of PDF Pass-Through Setting Screen)

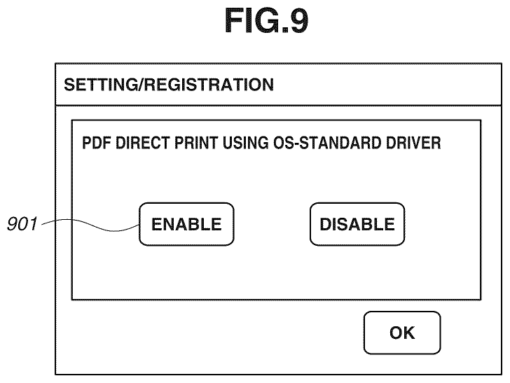

FIG. 9 illustrates an example of a PDF pass-through setting screen. The PDF pass-through setting 601 can be made by the user on the PDF pass-through setting screen displayed on the display unit 246 of the main body of the cloud print-compatible printer 104 before execution of printing.

When the user presses a setting change button 901 ([Enable] or [Disable]), the selected setting value of the PDF pass-through setting 601 is registered as the default value of the PDF pass-through setting. The registered PDF pass-through setting 601 is notified to the client terminal 101.

In the present exemplary embodiment, the settings are made as an example using a setting screen displayed on the printer itself. Alternatively, the settings can also be made on the client terminal 101 via the network 107, for example, without operating the printer itself. Attribute values specific to the printer vendor can also be defined as attribute values corresponding to the items defined in the industry standard specifications. The ability information is information indicating the functions installed in the printer, regardless of whether the items and attribute values are defined by the IPP.

Returning to the description of the flow of processing, the cloud print service 321 refers to, in step S303, the list of ability information sent by Get-printer-Attributes and returns the ability information of the cloud print-compatible printer 104 to the OS 313. In FIG. 3A, this step is described as “Response with ability information”.

For example, assume that the attribute value of paper size is specified by the IPP, Get-printer-Attributes.

In response to this, in a case where it has an attribute value of paper size, the cloud print service 321 returns a value associated with the attribute value (e.g., “A4”, “B5”, “Letter”, or the like). In contrast, in a case where the attribute value specified by Get-printer-Attributes does not exist in the queue of the cloud print-compatible printer 104 of the cloud print service 321, the cloud print service 321 does not return any associated value.

In step S304, the OS 313 updates device ability information (Print Device Capabilities (PDC)) on the basis of the ability information acquired from the cloud print service 321. In a case where the device ability information is updated, the device ability information managed by the client terminal 101 can be updated by executing this update process.

In step S305, the OS 313 notifies the print setting extension application 312 of an event and an API to be used to edit the device ability information.

In step S306, upon receipt of the edit event for device ability information from the OS 313, the print setting extension application 312 inquires about the ability information of the cloud print-compatible printer 104 via the cloud print service 321. In FIG. 3A, this step is described as “Acquire ability information”. At this time, the print setting extension application 312 inquires the cloud print service 321 and reads the ability information including the PDF pass-through setting 601 (see FIG. 6) stored and saved in the cloud print-compatible printer 104.

As in step S302, the inquiry is made using Get-printer-Attributes, and the ability information is acquired by specifying the setting item to be inquired. The ability information to be acquired in step S306 is not limited to the setting items and attribute values defined uniquely by the printer vendor, and can be setting items that have already been acquired by the OS 313.

In step S307, in a case where there is an inquiry from the print setting extension application 312 about the specific ability information, the cloud print-compatible printer 104 responds to the print setting extension application 312 via the cloud print service 321. In FIG. 3A, this step is described as “Response with ability information”. In the present exemplary embodiment, the ability information returned in step S307 is the ability information of the cloud print-compatible printer 104 that is saved and stored in the storage unit 324 by the cloud print service 321.

Upon receipt of the ability information request in step S306, the cloud print service 321 can respond with the ability information acquired from the cloud print-compatible printer 104. In this manner, the client terminal 101 can acquire, in step S306, information on whether the PDF pass-through setting in the cloud print-compatible printer 104, which will be described below, is “enabled” or “disabled”.

In step S308, upon acquisition of the ability information from the cloud print-compatible printer 104, the print setting extension application 312 edits the device ability information via a configuration information object, which is a data group necessary for editing the device ability information. For example, the device ability information is edited by converting the device ability information acquired in step S307, such as “stapleless binding”, “saddle folding”, and “page-description language (PDL) type that can be sent to the printer”, into the device ability information and added to the configuration information object. As the result of the editing, the ability information related to the standard setting items acquired through the inquiry by the OS 313, and the vendor-specific setting items and attribute values including the PDF pass-through setting 601, are stored in the storage unit 214, for the device ability information.

In step S309, the print setting extension application 312 transmits the edited device ability information to the OS 313. The OS 313 stores the device ability information acquired from the print setting extension application 312 in the storage unit 214, in association with the print queue.

In step S310, the OS 313 updates the device ability information, and then an object that triggers displaying the user interface (UI) of the print setting extension application 312, such as object 504 on the print setting initial screen (FIG. 5), becomes “enabled”. The object 504 remains grayed out until step S310 is completed.

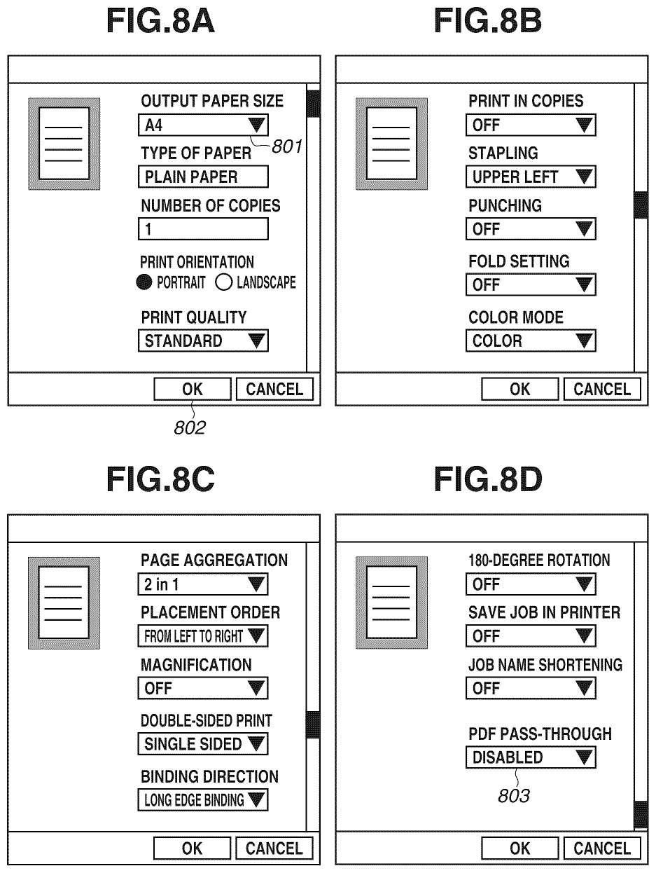

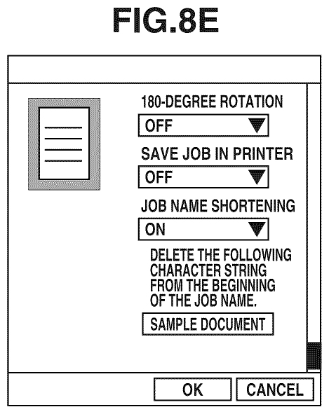

When the user selects the object 504 in step S311, the OS 313 starts the print setting extension application 312 and displays print setting screens such as those illustrated in FIGS. 8A to 8E (hereinafter, also collectively referred to as “FIG. 8”) on the display unit 216. Here, a UI reflecting device settings according to the ability information is started.

That is, a UI unit is provided to display information reflecting information indicating whether file conversion is enabled or disabled, which is included in the read print setting information, on the display screen of the display unit 216. The print setting screens do not depend on the type of the document generation application 315 to be used.

### (Print Setting Screens Without Print Setting Extension Application Installed)

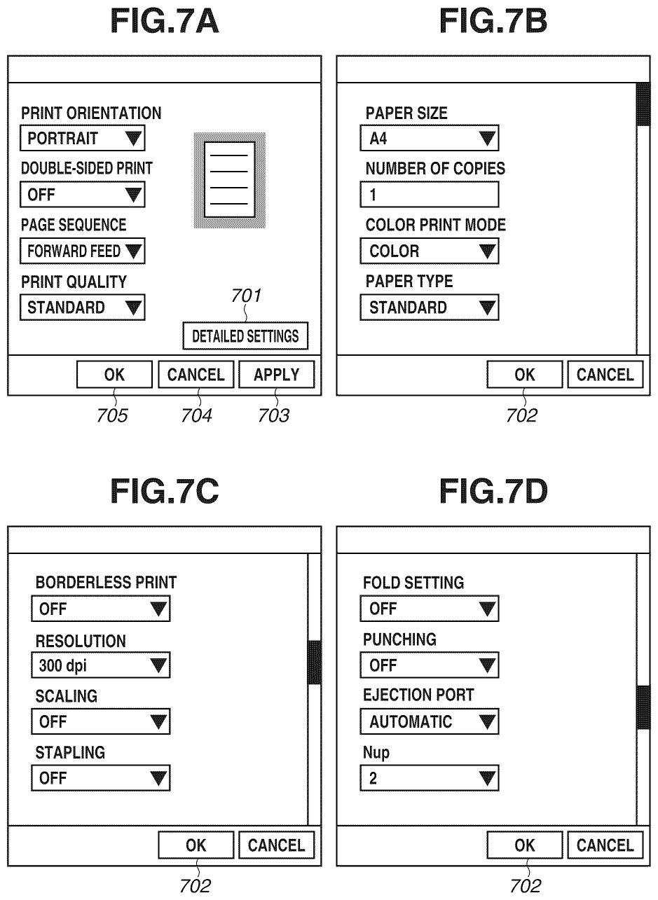

Print setting screens without a print setting extension application installed will be described with reference to FIGS. 7A to 7D (hereinafter, also collectively referred to as “FIG. 7”).

In a case where the print queue and the print setting extension application 312 are not linked, a standard print setting screen pre-installed in the OS 313 is displayed as illustrated in FIG. 7A. When a [Detailed Settings] button 701 on the standard print screen is pressed, a detailed print setting screen in FIG. 7B is displayed. On the detailed print setting screen, the setting items that cannot be displayed on the standard print setting screen of FIG. 7A are displayed. The detailed print setting screen illustrated in FIG. 7B is a screen that corresponds to a vertical movement operation of the scroll bar (SB), and the screen is scrolled vertically as illustrated in FIGS. 7C and 7D to display the settings of a plurality of setting items supported by the OS 313.

Referring to FIG. 7A, an [Apply] button 703 is a button for saving the print settings, a [Cancel] button 704 is a button for returning to the screen of FIG. 5 without saving the print settings, and an [OK] button 705 is a button for saving the print settings and returning to the screen illustrated in FIG. 5. An [OK] button 702 is also provided on the screens of FIGS. 7B to 7D.

### (Print Setting Screens With Print Setting Extension Application Installed)

Next, print setting screens with a print setting extension application installed will be described with reference to FIGS. 8A to 8E (hereinafter, also collectively referred to as “FIG. 8”).

The description will be returned to the print setting extension application 312. The print setting extension application 312 receives print setting information generated from print setting ability information generated by the OS 313 based on the device ability information, and displays an extended print setting screen as illustrated in FIG. 8A on the display unit 216. The screens illustrated in FIGS. 8A to 8E are displayed by scrolling the scroll bar (SB). The print setting extension application 312 displays the contents indicated by the device ability information as setting values (attribute values) on the extended print setting screen.

The print setting extension application 312 provides a function that allows the user to change the print settings as desired. In a case where the print settings are changed, the changed setting values can be saved. When the user selects an [OK] button 802 displayed on the print setting extension screen in FIG. 8A, the print settings are finalized. For example, assume that the user changes the setting item in an output paper size list box 801 on the UI from “A4” to “Letter”. In this case, the print setting information held by the print setting extension application 312 changes the output paper size from “A4” to “Letter”.

A list box 803 illustrated in FIG. 8D is a box for setting the PDF pass-through function to “Enabled” or “Disabled”. The list box 803 can reflect the ability information acquired by the print setting extension application 312 from the cloud print-compatible printer 104 in step S306.

That is, in a case where the cloud print-compatible printer 104 supports the PDF pass-through function, the print setting extension application 312 can display the print setting extension screen with the list box 803 enabled. In a case where the PDF pass-through setting 601 (FIG. 6) is set to “ON” on the printer, a setting screen is presented to the user in which the default setting of PDF pass-through in the list box 803 is set to “ON”. In a case where the PDF pass-through is “Enabled”, that is, in a case where the PDF pass-through setting 601 is “ON”, the PDF format data to be printed that is generated by the document generation application 315 is sent directly to the cloud print-compatible printer 104 without being converted to XPS format data.

In contrast, in a case where the PDF pass-through setting 601 is set to “OFF” on the printer, a setting screen is presented to the user in which the default setting of PDF pass-through in the list box 803 is set to “OFF”. In a case where the PDF pass-through is “Disabled”, that is, in a case where the PDF pass-through setting 601 is “OFF”, the PDF format data to be printed generated by the document generation application 315 is converted first to XPS format data once by the OS 313 (conversion unit). The print setting extension application then converts the data again to PDF format and sends the data to the cloud print-compatible printer 104.

The list box 803 for switching PDF pass-through between “Enabled” and “Disabled” is not displayed on the standard print setting screen provided by the OS 313. In step S312, in a case where the [OK] button 802 is selected by the user, the print setting extension application 312 acquires the print setting information set on the print setting screen from the print setting screen, passes the print setting information to the OS 313, and closes the extended print setting screen illustrated in FIG. 8. Then, upon completion of step S312, the print setting initial screen of FIG. 5 reflecting the setting values set by the print setting extension application 312 is displayed.

Returning to the description of the process sequence, in step S313, when the user presses the [Print] button 505 on the print setting initial screen illustrated in FIG. 5, a print execution instruction is issued to the OS 313. The OS 313 executes a print process based on the input instruction. In addition, data (PDF) output by the document generation application 315 is passed to the OS 313.

On the print setting initial screen illustrated in FIG. 5, the following three patterns of processing are assumed to be executed when the user selects the [Print] button 505.
(1) The first pattern corresponds to a case where the print setting extension application 312 linked to the selected print queue is installed in the client terminal 101, and the setting of the PDF pass-through function of the print setting extension application 312 is “Disabled”.
(2) The second pattern corresponds to a case where the print setting extension application 312 linked to the selected print queue is not installed.
(3) The third pattern corresponds to a case where the print setting extension application 312 linked to the selected print queue is installed, and the PDF pass-through function of the print setting extension application 312 is set to “Enabled”. Each of these patterns will be described below.

### ((1) First Pattern (PDF Pass-Through Setting is “Disabled”)

The first pattern corresponds to a case where the print setting extension application 312 corresponding to the print queue is installed in the client terminal 101 and the PDF pass-through function is set to “Disabled”.

In step S314, the OS 313 generates intermediate data in response to the print execution instruction, and sends the generated intermediate data and the print setting information edited on the print setting screen to the print setting extension application 312.

The intermediate data is data in XPS format, for example, and the print data is data in a PDL such as PDF or PWG-Raster, for example. PWG-Raster is an IPP-standard bitmap format. In the first pattern, a PDF file is generated as print data. The printing ability information specifically indicates print setting information converted into attribute values defined by the IPP.

In step S315, the print setting extension application 312 receives the intermediate data and the print setting information from the OS 313, and generates print data (PDF) and printing ability information. In FIG. 3B, this step is described only as “generate print data”.

At the time of generation of print data (PDF), the print setting extension application 312 can embed a font installed in the OS 313 in the print data (PDF).

In step S316, the print setting sends the generated print data (PDF) and printing ability information to the print queue of the OS 313.

In a case where a font is embedded in the print data (PDF), even in a case where the font does not exist in the printer, the printer can print the data in the font as it is in the original.

The above is the description of processing in the first pattern.

### ((2) Second Pattern (No Print Setting Extension Application Linked to the Selected Print Queue is Installed)

In the second pattern, when a print execution instruction is issued in step S313, the OS 313 of the client terminal 101 executes step S317 described below.

In step S317, the OS 313 converts the data output by the document generation application 315 into intermediate data, and generates print data and printing ability information based on the intermediate data and the print setting information. In FIG. 3B, step S317 is described as “Generate print data”, but printing ability information is also generated. The print data generated in this pattern can be data in PWG-Raster or PDF. Although the data is described as “PWG-Raster” in FIG. 3B, another PDL such as PDF can also be used.

### ((3) Third Pattern (PDF Pass-Through Setting is “Enabled”)

The third pattern corresponds to a case where the print setting extension application 312 corresponding to the selected print queue is installed in the client terminal 101 and the PDF pass-through setting is enabled. The PDF pass-through can be set to on in the print setting screen only in a case where the document generation application 315 can output a PDF file.

The third pattern is an issue to be solved by the present disclosure.

First, a conventional system having the issue will be described with reference to FIGS. 3A and 3B.

The OS 313 receives a PDF file and print specification information from the document generation application 315.

In step S318, the OS 313 sends the received PDF file and print specification information to the print setting extension application 312. In FIG. 3B, step S318 is described as “Pass PDF FILE”.

In step S319, the print setting extension application 312 generates printing ability information based on the received print setting information without changing the received PDF file. The print setting extension application 312 transmits the PDF file and the generated printing ability information to the OS 313. In FIG. 3B, step S319 is described only as “Pass PDF FILE to OS”.

As described above, in a case where the PDF pass-through setting is enabled, the PDF file output by the document generation application 315 is sent as it is to the OS 313. In a case where a font is not embedded in the PDF file, the PDF file without the embedded font is therefore sent as it is to the OS 313. As a result, in a case where the font does not exist in the printer, a substitute font is used for printing. Thus, characters that look different from the original can be printed, or character corruption can occur. Also, a print error can occur in a case where a substitute font is not found.

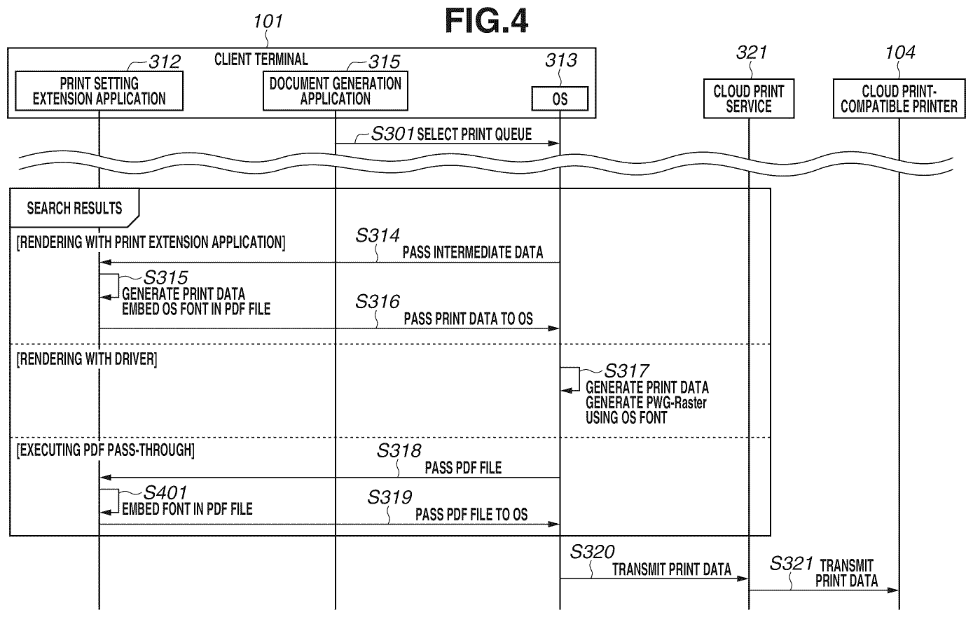

Next, a system that can solve the issue with the present disclosure will be described with reference to FIG. 4.

### (Processing of Embedding Font in PDF File (Print Setting Extension Application)

Steps S301 to S317 in FIG. 4 are similar to those in FIGS. 3A and 3B, and thus description thereof will be omitted.

In a case where the PDF pass-through setting in the third pattern is “Enabled”, the OS 313 sends, in step S318, the received PDF file and print specification information to the print setting extension application 312.

In step S401, the print setting extension application 312 checks the contents of the PDF file to see whether a font to be used is embedded. In a case where the font is not embedded, the print setting extension application 312 checks whether the font is installed in the OS 313. In a case where the font is installed in the OS 313, the print setting extension application 312 embeds the font in the PDF file.

In step S319, the print setting extension application 312 transmits the PDF file in which the font is embedded and the generated printing ability information to the OS 313.

As described above, in the first pattern, steps S314, S315, and S316 are executed, and rendering is performed with the print setting extension application 312. In the second pattern, step S317 is executed and rendering is performed with the driver. In the third pattern, steps S318, S319, and S401 are executed, and PDF pass-through is executed.

In step S320, the OS 313 transmits the print data and printing ability information received from the print setting extension application 312 or the print data and printing ability information generated by the OS 313, to the cloud print service 321 via the print queue.

In step S321, the cloud print service 321 transmits the print data and printing ability information received from the client terminal 101 to the cloud print-compatible printer 104.

The cloud print-compatible printer 104 can periodically inquire of the cloud print service 321 and acquire unprinted print data held on the cloud print service 321 and printing ability information corresponding to the print data. In step S301 in FIG. 3A, ability information is acquired and the print setting screen is displayed at the timing when the printer name is selected in the document generation application 315. However, the above-described processing can also be started at another timing. For example, the above-described processing can also be started at the timing when an object 404 displayed in the document generation application 315 is selected and operated.

As described above, in a case where a print queue is linked to the print setting extension application 312, the processing is performed from displaying the extended print setting screen (see FIG. 8) of the print setting extension application 312 to executing printing at the timing when the print queue is selected. The processing up to this point is the entire print process using the print setting extension application 312.

Hereinafter, the PDF pass-through will be described in detail.

In a first exemplary embodiment, in the case of performing the PDF pass-through, the print setting extension application 312 embeds a font in a PDF file.

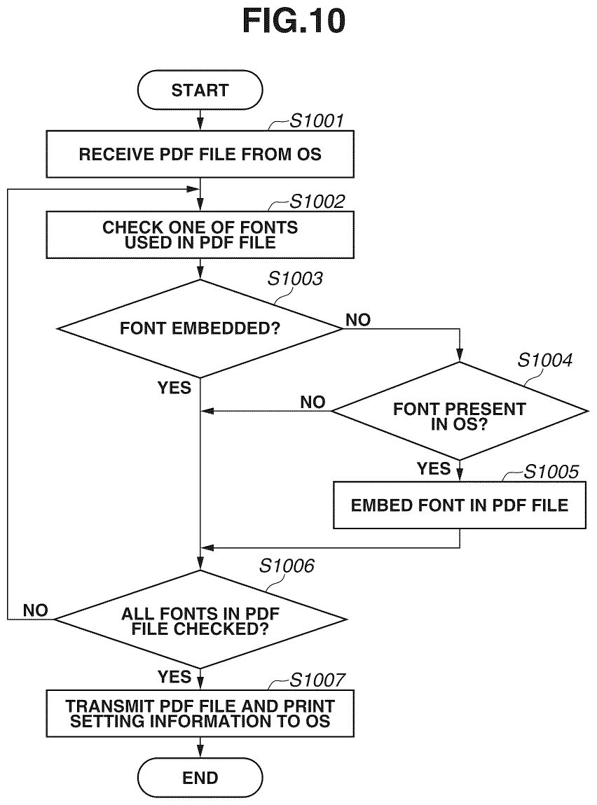

FIG. 10 is a flowchart of a process in which the print setting extension application 312 embeds a font in a PDF file in the case of performing the PDF pass-through. This process is implemented by the CPU 212 of the client terminal 101 executing the print setting extension application 312. The process in FIG. 10 is started after the OS 313 receives a print execution instruction from the document generation application 315 in step S313.

In step S1001, the print setting extension application 312 receives a PDF file sent from the OS 313. This step is equivalent to step S318 in FIG. 4.

Subsequent steps S1002 to S1006 are equivalent to step S401 in FIG. 4. They will be described in order.

In step S1002, the print setting extension application 312 selects one of the fonts used in the PDF file and checks the content.

In step S1003, the print setting extension application 312 determines whether the font checked in step S1002 is embedded in the PDF file. In a case where it is determined that the font is embedded (YES in step S1003), the processing proceeds to step S1006. In a case where it is determined that the font is not embedded (NO in step S1003), the processing proceeds to step S1004.

In step S1004, the print setting extension application 312 determines whether the font is installed in the OS. In a case where it is determined in step S1004 that the font is installed in the OS (YES in step S1004), the processing proceeds to step S1005. In a case where the font is not installed (NO in step S1004), the processing proceeds to step S1006.

In step S1005, the print setting extension application 312 embeds the font in the PDF file, and the processing proceeds to step S1006.

In step S1006, the print setting extension application 312 determines whether all fonts in the PDF file have been checked. In a case where it is determined that there is any font that has not yet been checked (NO in step S1006), the processing returns to step S1002, and steps S1002 to S1005 are performed on all fonts in the PDF file.

In contrast, in a case where it is determined in step S1006 that all fonts have been checked (YES in step S1006), the processing proceeds to step S1007.

In step S1007, the print setting extension application 312 sends the PDF file and the print setting information to the OS 313. This step is equivalent to step S319 in FIG. 4. This process is then ended.

By the above process, even in the case of performing the PDF pass-through, the print setting extension application 312 can embed a font installed in the OS in a PDF file. This allows the printer to print with the original font even when the font is not embedded in the PDF file. This prevents adverse phenomena such as garbled characters.

In the first exemplary embodiment, the print setting extension application 312 embeds a font in the PDF file in the case of performing the PDF pass-through. At this time, the font is embedded without the user's confirmation.

In contrast, in a second exemplary embodiment, steps for obtaining the user's confirmation are added to a process of embedding a font. This makes it possible to send the original PDF file as it is to the printer.

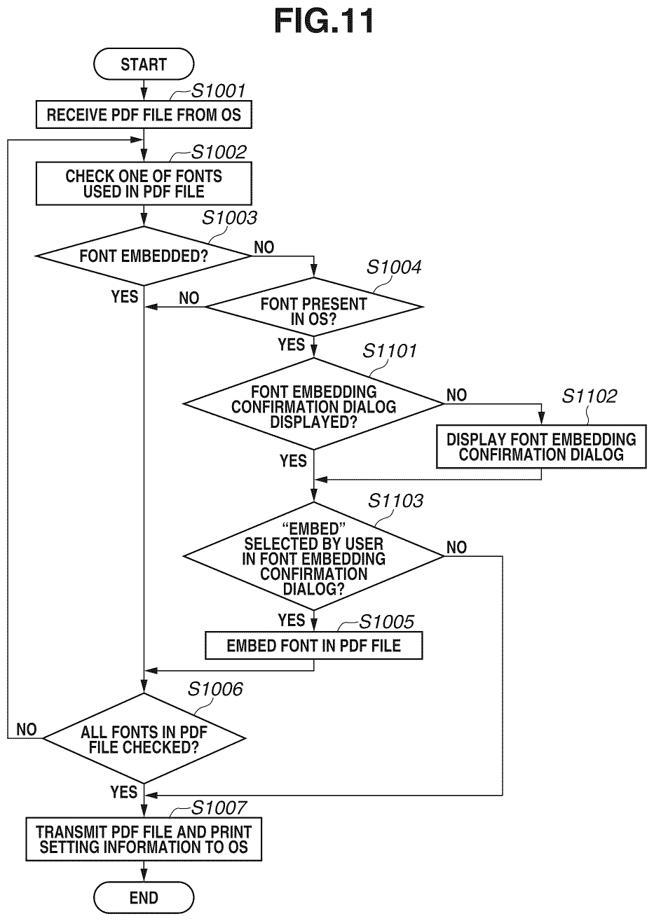

FIG. 11 is a flowchart of a font embedding process according to the second exemplary embodiment. Compared to the flowchart of the first exemplary embodiment illustrated in FIG. 10, steps S1101 to S1103 are added. This process is implemented by a CPU 212 of a client terminal 101 executing a print setting extension application 312. The details will now be described.

Steps S1001 to S1004 are similar to those in FIG. 10.

In a case where it is determined in step S1004 that the font exists in the OS (YES in step S1004), the processing proceeds to S1101.

In step S1101, the print setting extension application 312 determines whether a font embedding confirmation dialog has been displayed. In a case where it is determined that the font embedding confirmation dialog has never been displayed (NO in step S1101), the processing proceeds to step S1102. In a case where the font embedding confirmation dialog has been displayed in the course of checking another font (YES in step S1101), the processing proceeds to step S1103.

In step S1102, the print setting extension application 312 displays the font embedding confirmation dialog.

### (Font Embedding Confirmation Dialog)

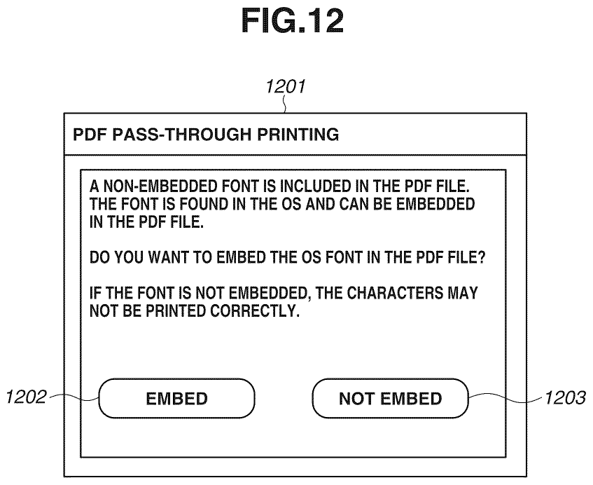

FIG. 12 illustrates an example of the font embedding confirmation dialog. Displayed in a font embedding confirmation dialog 1201 in FIG. 12 is the following confirming message as to whether to embed a font:
“A non-embedded font is included in the PDF file.
The font is found in the OS and can be embedded in the PDF file.
Do you want to embed the OS font in the PDF file?
If the font is not embedded, the characters may not be printed correctly”.
   Any messages other than the above are also acceptable as long as they have the same meaning.

The above message is presented to the user to prompt the user to select whether to embed the font. The user makes the selection by pressing an [Embed] button 1202 or a [Not embed] button 1203.

In step S1103, the print setting extension application 312 determines whether the user has selected [Embed] the font.

When it is determined in step S1103 that the user has selected [Embed] the font (YES in step S1103), the processing proceeds to step S1005.

In contrast, when it is determined in step S1103 that the user has selected “Not embed” the font (NO in step S1103), the loop for checking the fonts one by one is stopped, and the processing proceeds to step S1007. This is because when a font is not to be embedded, steps S1002 to S1006 are not necessary for other fonts.

This concludes the description of the font embedding process according to the second exemplary embodiment.

As described above, in the case of printing with the PDF pass-through, in a case where a font is not embedded in the PDF file, the user can select whether to embed the font from the OS in the PDF file.

In the first exemplary embodiment, in the case of performing the PDF pass-through, the print setting extension application 312 embeds a font in the PDF file. However, in a case where the font is not found in the OS, the process continues without embedding the font.

In contrast, in a third exemplary embodiment, if the font is not embedded in the PDF file and is not found even in the OS, the user is allowed to select whether to continue printing.

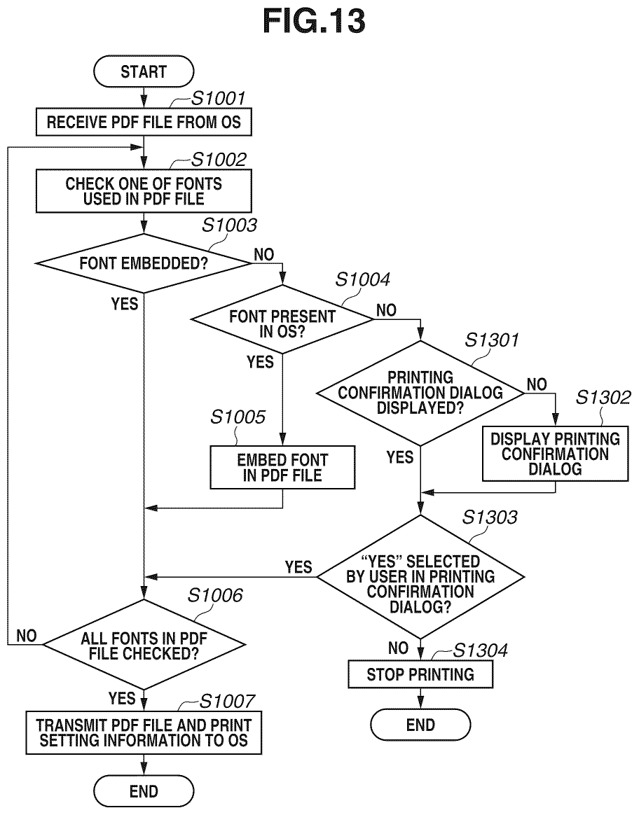

FIG. 13 is a flowchart of the third exemplary embodiment. Compared to the flowchart of the first exemplary embodiment in FIG. 10, steps S1301 to S1304 are added. This process is implemented by a CPU 212 of a client terminal 101 executing a print setting extension application 312. The details will now be described.

Steps S1001 to S1004 are similar to those in FIG. 10.

In a case where it is determined in step S1004 that the font does not exist in the OS (NO in step S1004), the processing proceeds to step S1301.

In step S1301, the print setting extension application 312 determines whether a print confirmation dialog has been displayed. If it is determined in step S1301 that the print confirmation dialog has not yet been displayed (NO in step S1301), the processing proceeds to step S1302. In a case where it is determined that the print confirmation dialog has been displayed (YES in step S1301), the processing proceeds to step S1303.

In step S1302, the print setting extension application 312 displays the print confirmation dialog.

### (Print Confirmation Dialog)

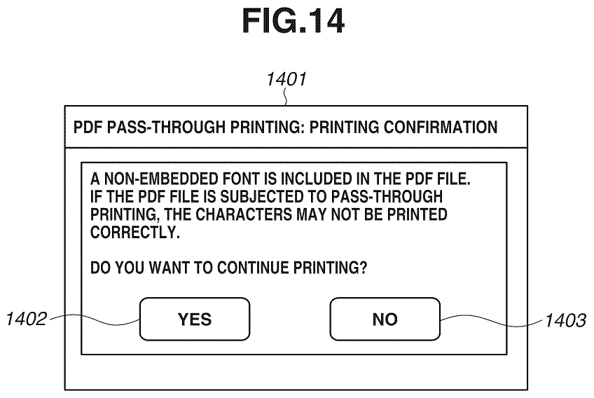

FIG. 14 illustrates an example of the print confirmation dialog. In a print confirmation dialog 1401, the following print confirming message is displayed:
“A non-embedded font is included in the PDF file.
If the PDF file is subjected to pass-through printing, the characters may not be printed correctly.
Do you want to continue printing?”
   Any messages other than the above are also acceptable as long as they have the same meaning.

The above message is presented to the user to prompt the user to select whether to continue printing. The user makes the selection by pressing a [YES] button 1402 or a [NO] button 1403.

In step S1303, the print setting extension application 312 determines whether the user has selected to continue printing. If it is determined in step S1303 that the user has selected to continue printing (YES in step S1303), the processing proceeds to step S1006. In step S1006, the processing is continued.

In contrast, in a case where it is determined in step S1303 that the user has selected not to continue printing (NO in step S1303), the processing proceeds to step S1304.

In step S1304, the print setting extension application 312 stops the print output, and this process is ended.

This concludes the description of the font embedding process according to the third exemplary embodiment.

According to the third exemplary embodiment, at the time of printing with the PDF pass-through, in a case where a font is not embedded in the PDF file and the font is not found in the OS, the user can select whether to continue printing.

In the first exemplary embodiment, the print setting extension application 312 embeds a font in the PDF file at the time of performing the PDF pass-through. However, whether the font is present in the printer is not taken into consideration.

In a fourth exemplary embodiment, a process of determining whether to execute a print process is performed, taking into consideration whether a font is present in the printer.

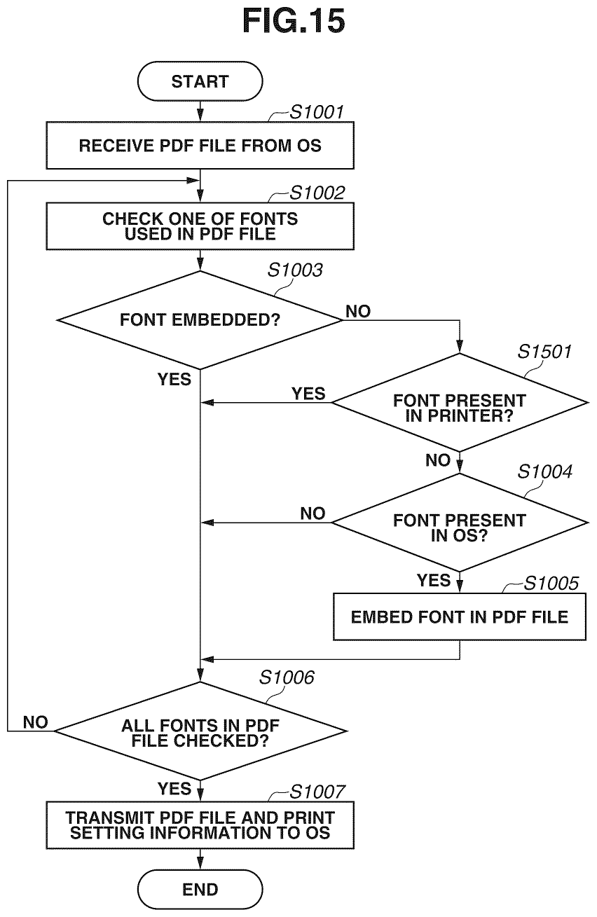

FIG. 15 is a flowchart of the fourth exemplary embodiment. Compared to the flowchart of the first exemplary embodiment in FIG. 10, step S1501 is added. This process is implemented by a CPU 212 of a client terminal 101 executing a print setting extension application 312. The details will now be described.

Steps S1001 to S1003 are similar to those in FIG. 10.

In a case where it is determined in step S1003 that the font is not embedded (NO in step S1003), the processing proceeds to step S1501.

In step S1501, the print setting extension application 312 determines whether the font exists in the printer. The font information in the printer is acquired from the printer in the response with ability information in step S307 in FIG. 3A. Based on the font information acquired in the response with ability information in step S307, it is determined whether the printer has the font that is not embedded in the PDF file.

In a case where it is determined in step S1501 that the font exists in the printer (YES in step S1501), the font is not embedded and the processing proceeds to step S1006. This is because when the font exists in the printer, the PDF file can be printed with the original font without embedding the font in the PDF file.

In contrast, in a case where it is determined in step S1501 that the font does not exist in the printer (NO in step S1501), the processing proceeds to step S1004. In this case, the font of the OS is embedded as in the first exemplary embodiment.

As described above, at the time of printing with the PDF pass-through, in a case where a font is not embedded in the PDF, it is possible to print with the PDF pass-through taking into consideration whether the font is present in the printer as well as in the OS.

In all the exemplary embodiments described so far, the PDF file and printing ability information transmitted from the client terminal 101 are transmitted to the printer via the cloud print server 102. However, embodiments of the present disclosure can also be applied to a case where a client terminal 101 and a cloud print-compatible printer 104 are directly connected without going through a cloud print service 321.

Embodiments of the present disclosure can be carried out by a process in which a program for implementing one or more functions of the above-described exemplary embodiments is supplied to a system or apparatus via a network or a storage medium, and one or more processors in a computer of the system or apparatus read and execute the program. Embodiments of the present disclosure can also be carried out by a circuit (e.g., an application specific integrated circuit (ASIC)) for implementing the one or more functions.

The exemplary embodiments of the present disclosure can also be implemented by executing the process described below. That is, software (program) for implementing the above-described exemplary embodiments is supplied to a system or apparatus via a network or a recording medium. Then, a computer (specifically, a processor such as a CPU or micro processing unit (MPU)) in the system or apparatus reads and executes the program code. In this case, the computer program and the recording medium storing the computer program are also covered by the present disclosure. In the above-described exemplary embodiments, the “ability information” and print data are communicated via the cloud print service 321, but direct communication with the cloud print-compatible printer 104 can also be performed.

### (Others)

(1) Print data from the client terminal 101 can also be sent “directly” to the cloud print-compatible printer 104 without involving the cloud print server 102 or the like.

At this time, the client terminal 101 and the cloud print-compatible printer 104 can be configured to be able to wirelessly communicate required information, for example.
(2) As the client terminal 101, a PC or a mobile terminal such as a smartphone or a tablet terminal can be used. For example, in a case of using a smartphone, a dedicated application for implementing the processing in the exemplary embodiments of the present disclosure can be downloaded from a specific website and installed on the smartphone. In this case, in a case where the distance between the smartphone and the cloud print-compatible printer 104 is relatively short, communication between the two can be enabled by Bluetooth®, as an example. In addition, a mobile terminal can be connected to the Internet via a portable rechargeable Wi-Fi® router, and a printing device can be connected to the Internet via a wired or wireless router. To connect the printing device to the router by wire, the printing device needs to have a LAN cable socket. Accordingly, the mobile terminal and the printing device are connected to be communicable with each other via a network such as the Internet. Moreover, since a portable rechargeable Wi-Fi router is used, the user can perform the processing according to the exemplary embodiments of the present disclosure at the location where the mobile terminal is carried.
(3) A UI can be displayed as a three-dimensional image to facilitate visual confirmation. In this case, the user views the three-dimensional image wearing goggles or special glasses, for example.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-117583, filed Jul. 23, 2024, which is hereby incorporated by reference herein in its entirety.

What is claimed is:

1. A non-transitory computer-readable storage medium storing an application program which causes an information processing apparatus to perform a control method, the application program cooperating with an Internet Printing Protocol (IPP) Class Driver, the control method comprising:
accepting a setting on conversion of a file to be printed; and
when a setting not to perform the conversion is accepted and a font used in the file to be printed is not embedded in the file to be printed, embedding the font.

2. The non-transitory computer-readable storage medium according to claim 1, wherein the file to be printed is a Portable Document Format (PDF) file.

3. The non-transitory computer-readable storage medium according to claim 1, wherein the control method further comprises, when the font is present in an operating system, embedding the font.

4. The non-transitory computer-readable storage medium according to claim 3, wherein the control method further comprises, when the font is present in the operating system, displaying a screen to accept the font embedding instruction from a user.

5. The non-transitory computer-readable storage medium according to claim 4, wherein the control method further comprises, upon receipt of the font embedding instruction from the user, embedding the font.

6. The non-transitory computer-readable storage medium according to claim 3, wherein the control method further comprises, when the font is not present in the operating system, displaying a screen to accept a print continuance instruction from a user.

7. The non-transitory computer-readable storage medium according to claim 6, wherein the control method further comprises, upon receipt of the print continuance instruction from the user, stopping output of print data.

8. The non-transitory computer-readable storage medium according to claim 3, wherein the control method further comprises, in a case where the font exists in an image forming apparatus that performs outputting, not embedding the font.

9. The non-transitory computer-readable storage medium according to claim 1, wherein the control method further comprises, by the IPP Class Driver, generating print data that is printable by image forming apparatuses from a plurality of manufacturers, and outputting the print data to the image forming apparatuses from the plurality of manufacturers.

10. A control method of an information processing apparatus having an IPP Class Driver and an application program configured to cooperate with the IPP Class Driver, the control method comprising:
accepting a setting on conversion of a file to be printed; and
when a setting not to perform the conversion is accepted and a font used in the file to be printed is not embedded in the file to be printed, embedding the font.

11. An information processing apparatus having an IPP Class Driver and an application program configured to cooperate with the IPP Class Driver, comprising:
an acceptance unit configured to accept a setting on conversion of a file to be printed; and
an embedding unit configured to, when a setting not to perform the conversion is accepted and a font used in the file to be printed is not embedded in the file to be printed, embed the font.
